(19) United States
(12) Patent Application Publication
(10) Pub. No.: US 2011/0110641 A1
(43) Pub. Date: May 12, 2011

(54) METHOD FOR REAL-SENSE BROADCASTING SERVICE USING DEVICE COOPERATION, PRODUCTION APPARATUS AND PLAY APPARATUS FOR REAL-SENSE BROADCASTING CONTENT THEREOF

(75) Inventors: Jae-Kwan Yun, Daejeon (KR); Jong-Hyun Jang, Daejeon (KR)

(73) Assignee: Electronics and Telecommunications Research Institute, Daejeon (KR)

(21) Appl. No.: 12/912,917

(22) Filed: Oct. 27, 2010

(30) Foreign Application Priority Data
Nov. 11, 2009 (KR) 10-2009-0108398
Jun. 10, 2010 (KR) 10-2010-0054991

(51) Int. Cl. H04N 5/932; H04N 7/173

(52) U.S. Cl. 386/201; 725/105; 386/E05.003

(57) ABSTRACT

Provided is a method for a real-sense broadcasting service using device cooperation. The method for the real-sense broadcasting service may map and control synchronization of real-sense reproduction devices around a user, deviating from an existing real-sense broadcasting based on an image and a sound, and may reproduce a real-sense effect using cooperation of a device group with respect to a particular effect.

### CROSS REFERENCE TO RELATED APPLICATIONS

This application claims priority to Korean Patent Application No. 10-2009-0108398 filed on Nov. 11, 2009 and Korean Patent Application No. 10-2010-0054991 filed on Jun. 10, 2010, the entire contents of which are herein incorporated by reference.

### BACKGROUND OF THE INVENTION

1. Field of the Invention

The present invention relates to a real-sense broadcasting system, and more particularly, to method for a real-sense broadcasting service, real-sense broadcasting content production apparatus and real-sense broadcasting content play apparatus that may embody real-sense broadcasting using cooperation between a plurality of apparatuses (devices) in order to perform a single media multiple devices (SMMD)-based real-sense playback service.

2. Description of the Related Art

In a ubiquitous information technology (IT) era, a real-sense technology satisfying five senses of a human being and an intellectual technology based on autonomous cooperation between devices are organically applied to media.

It may be difficult to embody the above technology using a scheme of playing media in a single device. That is, when various devices for expressing real-sense and media interoperate with each other, and the devices operate according to information of the media, it may be possible to embody the above technology.

A current media service generally corresponds to a single media single device (SMSD)-based service where single media is played on a single device. However, to maximize the media playback effect in a ubiquitous home, a single media multiple devices (SMMD)-based service where single media is played in interoperation with multiple devices is required.

### SUMMARY OF THE INVENTION

An aspect of the present invention is to provide a method for a real-sense broadcasting service that can configure real-sense broadcasting using device cooperation.

Another aspect of the present invention is to provide a real-sense broadcasting content production apparatus for a real-sense broadcasting service.

Another aspect of the present invention is to provide a real-sense broadcasting content play apparatus for a real-sense broadcasting service.

An exemplary embodiment of the present invention provides a method for a real-sense broadcasting service using a real-sense broadcasting content production apparatus, including: generating media data by encoding at least one media source; generating real-sense effect data by encoding at least one metadata, and generating a media file by inserting the real-sense effect data into the media data; and converting the media file to a broadcasting signal and thereby outputting.

Another embodiment of the present invention provides a method for a real-sense broadcasting service using a real-sense broadcasting content play apparatus, including: separating media data and real-sense effect data from a received broadcasting signal; generating image data by decoding the media data, and playing the image data using at least one display device; and generating effect data by decoding the real-sense effect data, and reproducing the effect data using at least one real-sense reproduction device by controlling the effect data to be synchronized with a play time of the image data.

Still another embodiment of the present invention provides a real-sense broadcasting content production apparatus of a real-sense broadcasting system, the apparatus including: a media file generator to generate media data by encoding at least one collected media source; a metadata generator to generate real-sense effect data by encoding at least one metadata corresponding to the media data; a mixing unit to output a media file by inserting the real-sense effect data into the media data; and a signal converter to convert the media file to a broadcasting signal and thereby output.

Yet another embodiment of the present invention provides a real-sense broadcasting content play apparatus of a real-sense broadcasting system, the apparatus including: a media parser to separate media data and real-sense effect data from a received broadcasting signal; a media controller to control a play time of the media data to be synchronized based on a synchronization control signal; a device controller to control a reproduction time of the real-sense effect data to be synchronized with the media data based on the synchronization control signal; and a synchronization control unit to generate and output a control signal for controlling a play synchronization of the media data or a reproduction synchronization of the real-sense effect data.

A method and system for a real-sense broadcasting service according to the embodiments of the present invention may add effect data for application of a real-sense service and the like to existing broadcasting media including moving picture, audio, and text, and thereby may reproduce a real-sense effect that is not provided by the existing broadcasting media.

Also, by playing single media using a plurality of devices instead of playing single media using a single device, it is possible to transfer a large amount of information at one time.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a real-sense broadcasting system according to an exemplary embodiment of the present invention;

FIG. 2 is a schematic configuration diagram of a signal converter of FIG. 1;

FIG. 3 is an operational flowchart of a content production apparatus of FIG. 1;

FIG. 4 is an operational flowchart of the signal converter of FIG. 1;

FIG. 5 is an operational flowchart of a content play apparatus of FIG. 1;

FIG. 6 is a flowchart of a synchronization control operation of a synchronization control unit;

FIG. 7A and FIG. 7B are diagrams illustrating a synchronization error correcting operation of the synchronization control unit; and

FIG. 8A, 8B and FIG. 9 are diagrams illustrating a synchronization error correcting operation of the synchronization control unit.

### DETAILED DESCRIPTION OF THE PREFERRED EMBODIMENTS

The accompanying drawings illustrating embodiments of the present invention and contents described in the accompanying drawings should be referenced in order to fully appreciate operational advantages of the present invention and objects achieved by the embodiments of the present invention.

Hereinafter, the present invention will be described in detail by describing preferred embodiments of the present invention with reference to the accompanying drawings. Like elements refer to like reference numerals shown in the drawings.

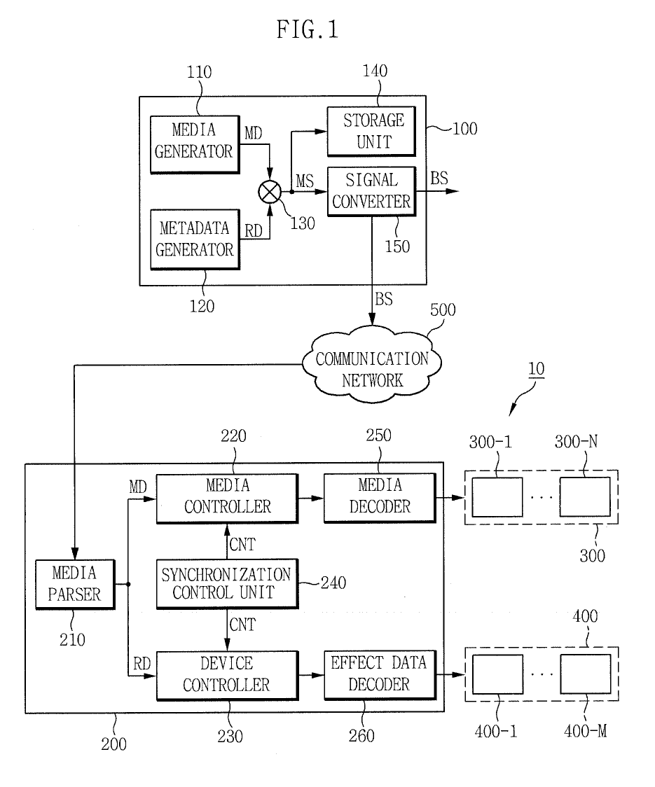

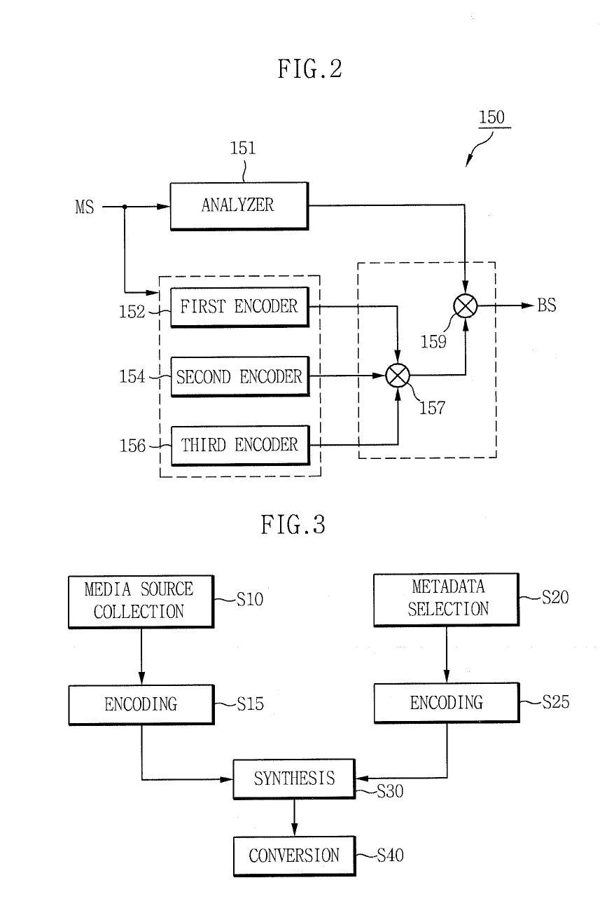

FIG. 1 is a schematic configuration diagram of a real-sense broadcasting system according to an exemplary embodiment of the present invention, and FIG. 2 is a schematic configuration diagram of a signal converter of FIG. 1.

Referring to FIG. 1, the real-sense broadcasting system 10 may include a content production apparatus 100, a content play apparatus 200, and a communication network 500.

The content production apparatus 100 also referred to as a broadcasting server may produce various types of image contents and various types of real-sense contents corresponding thereto, integrate them into a single signal, and thereby transmit the integrated signal to the content play apparatus 200.

The content production apparatus 100 may include a media generator 110, a metadata generator 120, a mixing unit 130, a storage unit 140, and the signal converter 150.

The media generator 110 may collect a plurality of media sources from an external content storage server (not shown). Also, the media generator 110 may generate media data MD by encoding the plurality of collected media sources using a predetermined format.

The plurality of media sources may include a plurality of image (video) sources or a plurality of sound (audio) sources.

The media generator 110 may generate media data MD including a single piece of image data from the plurality of collected media sources, and may also generate media data MD, including a data for a main image and a plurality of pieces of sub images, from the plurality of collected media sources.

In this case, each image data may include at least one media source, that is, media source including a plurality of video sources and a plurality of audio sources.

The media generator 110 may further include an MP4 encoder (not shown) to encode the plurality of collected media sources using a motion picture compression technology, for example, a motion picture experts group4 (MPEG4) format and thereby output. The media generator 110 may generate media data MD using the above encoder.

The metadata generator 120 may encode and output at least one metadata corresponding to the media data MD generated by the media generator 110.

For example, the metadata generator 120 may select and extract at least one metadata from a plurality of pieces of metadata stored in an external data storage server (not shown).

The metadata generator 120 may encode the extracted at least one metadata and thereby output the encoded metadata, that is, real-sense effect data RD.

In this case, each of the plurality of pieces of metadata may be programmed using a programming language such as an extensible markup language (XML) in order to reproduce various real-sense effects such as a scent effect, a light effect, a wind effect, a vibration effect, a motion effect, and the like.

The metadata generator 120 may select at least one metadata from the plurality of pieces of metadata programmed and thereby stored, based on information associated with a type of media data MD, a characteristic thereof, and the like, and may verify a reliability of the selected metadata and then extract the verified metadata.

Also, the metadata generator 120 may output the real-sense effect data RD by encoding the extracted at least one metadata using the same scheme as the media data MD. For this, the metadata generator 120 may further include a metadata encoder (not shown).

Meanwhile, according to various embodiments of the present invention, the metadata generator 120 may also share the encoder of the media generator 110.

The mixing unit 130 may output at least one media file MS by synthesizing the media data MD and the real-sense effect data RD.

For example, the mixing unit 130 may generate the media file MS by inserting the real-sense effect data RD into a metadata track of the media data MD, and may output the media file MS.

When the media data MD corresponds to real-time media such as sport relay broadcasting and the like, the real-sense effect data RD may need to be inserted into the media data MD in real time.

Accordingly, the real-sense effect data RD output from the metadata generator 120 may be input in real time into the signal converter 150 to be described later, and be mixed with a broadcasting signal BS output from the signal converter 150 and thereby be inserted.

The storage unit 140 may store the media file MS output from the mixing unit 130. When the media file MS is stored in a predetermined storage device such as a CD, a DVD, and the like, and thereby is played only via a corresponding device, the storage unit 140 may store the media file MS in an elementary stream (ES) form. When the media file MS is transmitted via the communication network 500 and thereby is played, the storage unit 140 may store the media file MS in an access unit (AU) form.

The media file MS stored in the storage unit 140 may be output to the signal converter 150 according to a user request and the like.

The signal converter 150 may convert the media file MS output from the mixing unit 130 to a signal suitable for a transmission, that is, to the broadcasting signal BS, and may output the converted broadcasting signal BS via the communication network 500.

The signal converter 150 may convert the media file MS to the broadcasting signal BS using a scheme of encoding the media file MS according to a predetermined communication standard, and the like.

Referring to FIG. 1 and FIG. 2, the signal converter 150 may include an analyzer 151, a plurality of encoders 152, 154, and 156, a first synthesizer 157, and a second synthesizer 159.

The analyzer 151 may generate various information data by analyzing a media file MS, and may output the generated information data.

Each of the encoders 152, 154, and 156 may encode and output the media file MS.

Each of the first encoder 152, the second encoder 154, and the third encoder 156 may encode each data of the media file MS using a transport stream (TS) format, that is, an MPEG2TS format, and may thereby output.

Encoded data output from the plurality of encoders 152, 154, and 156 may be synthesized into a single piece of data by the first synthesizer 157. The single piece of data synthesized by the first synthesizer 157 may be synthesized with the various information data output from the analyzer 151 via the second synthesizer 159.

That is, the first synthesizer 157 and the second synthesizer 159 may generate a broadcasting signal BS by combining the plurality of pieces of encoded data and the various information data output from the analyzer 151, and may output the generated broadcasting signal BS.

The generated broadcasting signal BS may be output to the communication network 500 using a user datagram protocol (UDP)/Internet protocol (IP).

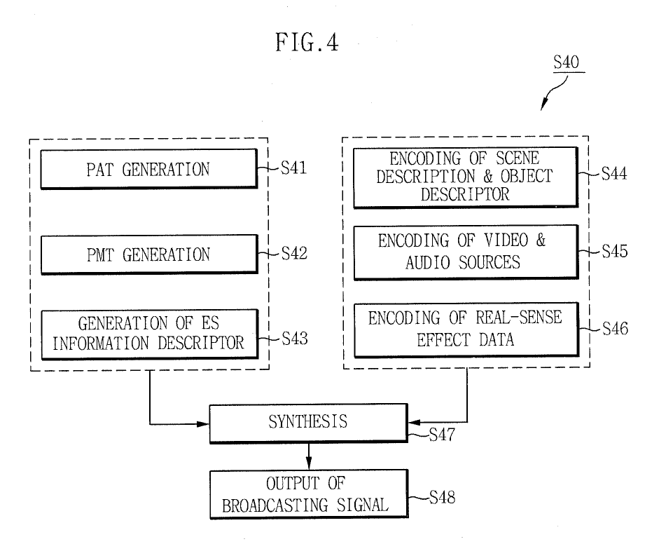

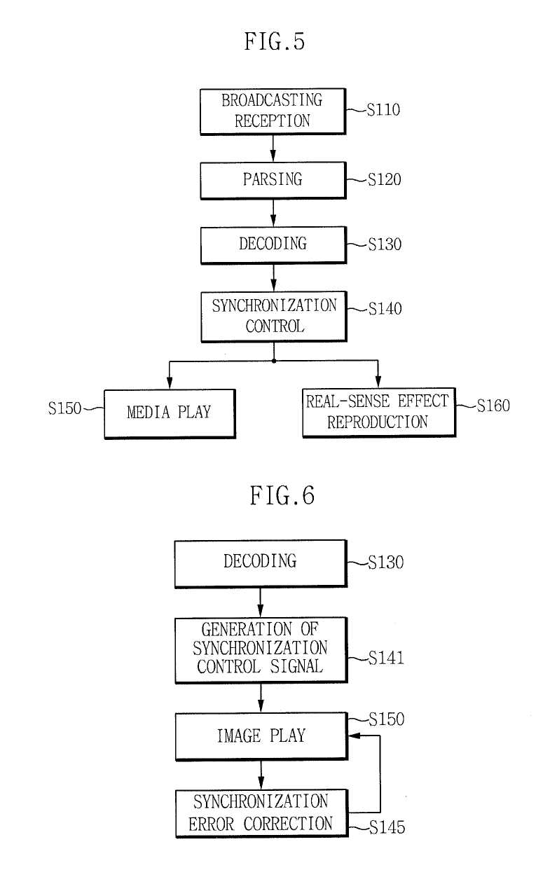

FIG. 3 is an operational flowchart of the content production apparatus 100 of FIG. 1, and FIG. 4 is an operational flowchart of the signal converter 150 of FIG. 1.

Referring to FIG. 1 and FIG. 3, the media generator 110 of the content production apparatus 100 may collect a plurality of media sources (S10), and may generate media data MD by encoding the plurality of collected media sources (S15).

The metadata generator 120 of the content production apparatus 100 may select, from a plurality of pieces of metadata, at least one metadata corresponding to the media data MD (S20), and may generate encoded metadata, that is, real-sense effect data (RD) by encoding the selected metadata (S25).

The mixing unit 130 may generate a media file MS by inserting the real-sense effect data RD into the media data MD, and may output the generated media file MS (S30).

The signal converter 150 may generate a broadcasting signal BS by converting the media file MS, and may output the generated broadcasting signal BS via the communication network 500 (S40).

In the meantime, according to another embodiment of the present invention, the real-sense effect data RD may be inserted into the broadcasting signal BS in real time.

For example, when the media data MD corresponds to real-time media, the media data MD may be converted to the broadcasting signal BS, and the real-sense effect data RD may be inserted into the broadcasting signal BS in real time and thereby be output.

Referring to FIG. 1, FIG. 2, and FIG. 4, the analyzer 151 of the signal converter 150 may generate and output various information data by analyzing a media file MS.

For example, the analyzer 151 may generate and output a program association table (PAT) by analyzing the media file MS (S41).

Also, the analyzer 151 may generate and output a program map table (PMT) by analyzing the media file MS (S42).

Also, the analyzer 151 may identify a video track and an audio track by analyzing the media file MS, and thereby may generate and output an ES information descriptor (S43).

In this case, there is no particular constraint on a generation order of various information data generated by the analyzer 151.

Each of the encoders 152, 154, and 156 of the signal converter 150 may encode the media data MS and thereby output a plurality of pieces of encoded data.

For example, the first encoder 152 may encode and output each of a scene description and an object descriptor of the media file MS (S44).

Also, the second encoder 154 may encode and output a video source and an audio source of the media file MS (S45).

Also, the third encoder 156 may encode and output real-sense effect data RD of the media file MS (S46).

In this case, there is no particular constraint on an encoding order of the media file MS performed by the plurality of encoders 152, 154, and 156.

Encoded data output from the encoders 152, 154, and 156 may be synthesized into a single piece of data. The synthesized single piece of data may be synthesized with each of a plurality of pieces of information data, that is, a plurality of pieces of information data output from the analyzer 151 (S47).

Accordingly, a broadcasting signal BS in which the plurality of pieces of encoded data are synthesized with the plurality of pieces of information data may be generated and be output (S48).

Referring again to FIG. 1, the content play apparatus 200 also referred to as a broadcasting receiving apparatus may receive the broadcasting signal BS transmitted from the content production apparatus 100 via the communication network 500.

Here, the communication network 500 may be a wired/wireless broadcasting communication network or a wired/wireless Internet network.

The content production apparatus 200 may play media data MD included in the broadcasting signal BS, that is, an image signal using each of display devices 300_1, . . . , 300_N (N denotes a natural number), or may reproduce real-sense effect data RD included in the broadcasting signal BS using each of the real-sense reproduction devices 400_1, . . . , 400_M (M denotes a natural number).

Here, each of the display devices 300_1, . . . , 300_N may indicate a display device such as a TV, a monitor, and the like, and each of the real-sense reproduction devices 400_1, . . . , 400_M may indicate a scent device, a vibration device, an air blower, and the like.

The content play apparatus 200 may include a media parser 210, a media controller 220, a device controller 230, a synchronization control unit 240, a media decoder 250, and an effect data decoder 260.

The media parser 210 may separate the media data MD and the real-sense effect data RD by parsing the broadcasting signal BS transmitted via the communication network 500.

Also, the media parser 210 may separate main image data and sub image data from the media data MD.

The media controller 220 may output, to the media decoder 250, the media data MD transmitted from the media parser 210, based on a control signal CNT output from the synchronization control unit 240, for example, a control signal for controlling synchronization of the media data MD.

The media decoder 250 may decode the media data MD output from the media controller 220, and may output the decoded media data MD, that is, image data to each of the display devices 300_1, . . . , 300_N to thereby be played thereon.

In this case, play synchronization of the image data may be controlled by the control signal CNT of the synchronization controller 240.

The device controller 230 may output, to the effect data decoder 260, the real-sense effect data RD transmitted from the media parser 210, based on the control signal CNT output from the synchronization control unit 240, for example, a control signal for controlling synchronization of the real-sense effect data RD.

The effect data decoder 260 may decode the real-sense effect data RD output from the device controller 230, and may output the decoded real-sense effect data, that is, effect data to each of the real-sense reproduction devices 400_1, . . . , 400_M to thereby be played thereon.

In this case, reproduce synchronization of the effect data may be controlled by the control signal CNT of the synchronization control unit 240.

Each of the display devices 300_1, . . . , 300_N may play the synchronization-controlled image data output from the media controller 250.

Each of the real-sense reproduction devices 400_1, . . . , 400_M may reproduce the synchronization-controlled effect data output from the effect data decoder 260.

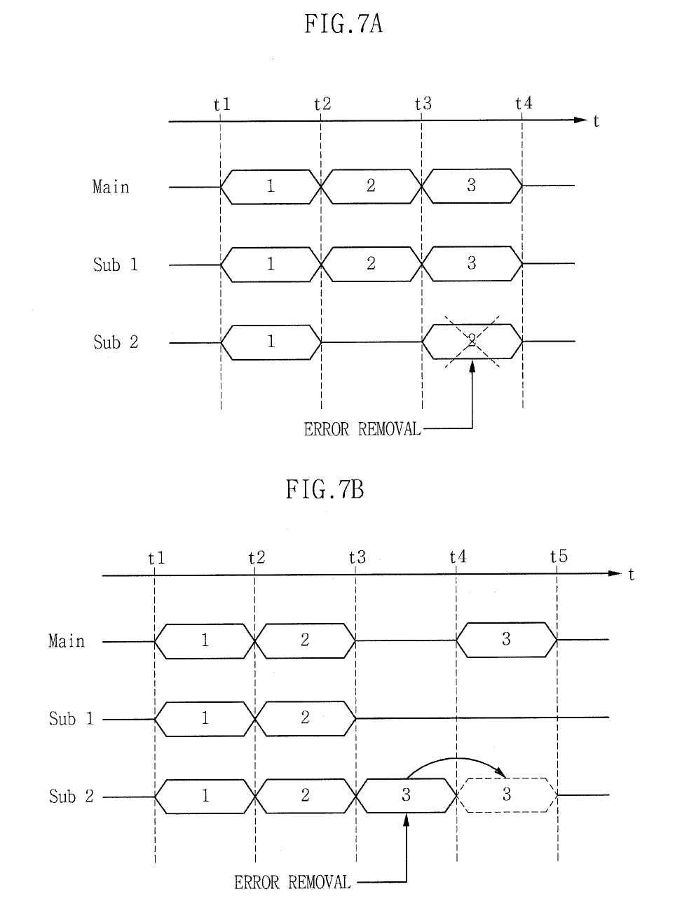

FIG. 5 is an operational flowchart of the content play apparatus of FIG. 1.

Referring to FIG. 1 and FIG. 5, the media parser 210 of the content play apparatus 200 may receive a broadcasting signal BS via the communication network 500 (S110), and may perform a parsing operation of separating media data MD and real-sense effect data RD from the broadcasting signal BS (S120).

The separated media data MD may be synchronization-controlled by the media controller 220 and thereby be provided to the media decoder 250. The media decoder 250 may decode the synchronization-controlled media data MD to thereby output image data.

Also, the separated real-sense effect data RD may be synchronization-controlled by the device controller 230 and thereby be provided to the effect data decoder 260. The effect data decoder 260 may decode the synchronization-controlled real-sense effect data RD to thereby output effect data (S130).

In this case, the media controller 220 or the device controller 230 may control synchronization of the media data MD or the real-sense effect data RD according to a control signal CNT output from the synchronization control unit 240.

The media decoder 250 may output the image data to at least one display device selected from the plurality of display devices 300_1, . . . , 300_N to thereby be played thereon.

For example, when the separated media data MD includes a single piece of image data, the media decoder 250 may select one device, for example, a TV from the plurality of display devices 300_1, . . . , 300_N, and may output the image data, that is, the single piece of image data to the selected display device to thereby be played thereon.

Also, when the separated media data MD include data for a main image and a plurality of pieces of sub images, the media decoder 250 may select, from the plurality of display devices 300_1, . . . , 300_N, one device to play the single piece of main image data, for example, a TV and a plurality of devices to respectively play the plurality of pieces of sub image data, for example, a monitor, a mobile phone, and the like.

The image data, that is, the main image data may be output to the selected one device and thereby be played. The sub image data may be output to the selected plurality of devices and thereby be played.

The effect data decoder 260 may output and reproduce the effect data to at least one real-sense reproduction device that is selected from the plurality of real-sense reproduction devices 400_1, . . . , 400_M.

In the meantime, a play or reproduction start time of each of the image data played in each of the display devices 300_1, . . . , 300_N or the effect reproduction data reproduced in each of the real-sense reproduction devices 400_1, . . . , 400_M may be controlled (S140).

Each of the display devices 300_1, . . . , 300_N may play the image data output from the media decoder 250. In this case, a play time of the image data may be synchronization-controlled according to a synchronization control of the media controller 220, based on the control signal CNT output from the synchronization control unit 240 (S150).

Also, each of the real-sense reproduction devices 400_1, . . . , 400_M may reproduce the effect data output from the effect data decoder 260. In this case, a reproduction time of the effect data may be synchronization-controlled according to a synchronization control of the device controller 230, based on the control signal CNT output from the synchronization controller 240 (S160).

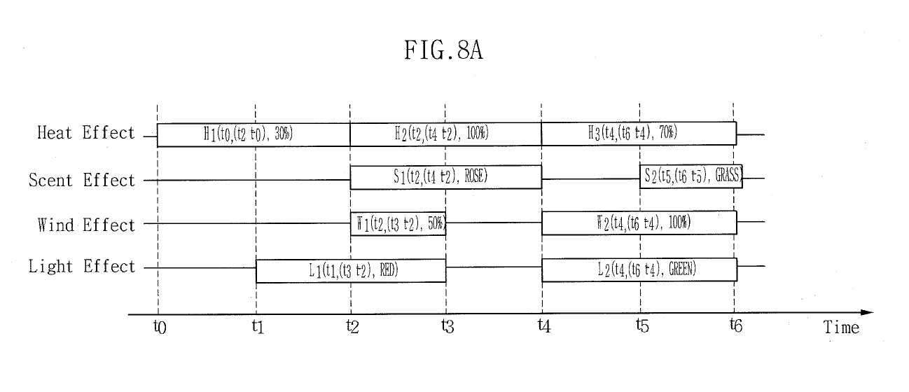

FIG. 6 is a flowchart of a synchronization control operation of the synchronization control unit. In the present embodiment, the synchronization control operation of the synchronization control unit 240 with respect to play of the image data output from the media decoder 250 will be described. However, the synchronization control operation of the synchronization control unit 240 with respect to reproduction of the effect data output from the effect data decoder 260 will also be similar.

Referring to FIG. 1 and FIG. 6, the media decoder 250 may output image data by decoding synchronization-controlled media data MD provided from the media controller 220 (S130).

In this case, the image data may be a single piece of image data including a plurality of video sources and a plurality of audio sources.

Also, the media decoder 250 may select, from the plurality of display devices 300_1, . . . , 300_N, one display device desired to play the decoded single piece of image data.

The synchronization control unit 240 may generate a control signal CNT for synchronization-controlling a play time between the video source and the audio source of the media data MD, and may output the generated control signal CNT to the media controller 220 (S141).

According to another embodiment of the present invention, the synchronization control unit 240 may output the control signal CNT to the one display device selected by the media decoder 250.

The one display device selected by the media decoder 250 may synchronize the play time between the video sources and the audio sources of the image data that are synchronization-controlled by the media controller 220 and thereby are decoded, and thereby play the image data (S150).

In this case, the synchronization control unit 240 may output, to the media controller 220, the control signal CNT for correcting a synchronization error of the image data played by the one display device, for example, a dislocation of the play time between the video source and the audio source, and thereby perform a synchronization error correcting operation (S145).

In the meantime, the image data output from the media decoder 250 may include data for a main image and a plurality of pieces of sub images.

The media decoder 250 may select, from the plurality of display devices 300_1, . . . , 300_N, one display device to play the single piece of decoded main image data, and may select, from remaining display devices, display devices to display the plurality of pieces of decoded sub image data.

The synchronization control unit 240 may generate a control signal CNT for synchronization-controlling an operation time (i.e., image data play time) between the plurality of display devices selected by the media decoder 250, that is, between the display device playing the main image data and the display devices playing the sub image data, and may output the generated control signal CNT to the selected media controller 220 (S141).

The plurality of display devices selected by the media decoder 250 may synchronize the play time between the video sources and the audio sources of the image data that are synchronization-controlled by the media controller 220 and thereby are decoded, and thereby play the image data (S150).

In this case, the synchronization control unit 240 may output, to the media controller 220, the control signal CNT for correcting a synchronization error of the main image data and the sub image data played by the plurality of display devices, for example, a dislocation of the play time between the main image data and the sub image data, and thereby perform a synchronization error correcting operation (S145).

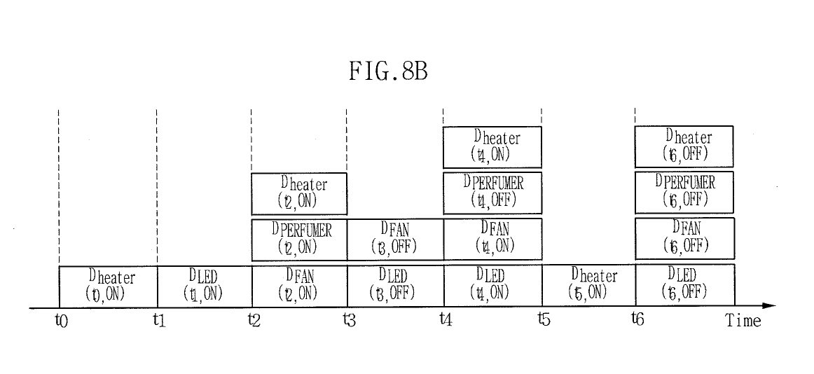

FIG. 7A and FIG. 7B are diagrams illustrating a synchronization error correcting operation of the synchronization control unit. In the present embodiment, an operation of correcting a synchronization error occurring between main image data and sub image data played by a plurality of display devices, described above with reference to FIG. 6, will be described.

Referring to FIG. 1 and FIG. 7A, it is assumed that on a time axis t, main image data Main of image data is received and is being played by a first display device among the plurality of display devices 300_1, . . . , 300_N, and two sub image data Sub1 and Sub2 are received and thereby are being played respectively by a second display device and a third display device among the plurality of display devices 300_1, . . . , 300_N. Here, the first, the second, and the third display devices are display devices selected for ease of description.

In this case, due to an occurrence of a synchronization error, a second track of the second sub image Sub2 that needs to be received by the third display device and thereby be synchronized and be played with a second track of the main image data Main in a time t2-t3 of the time axis t may be received in a time t3-t4 of the time axis t.

To correct the above synchronization error, the synchronization control unit 240 may output a control signal CNT for removing the second track of the second sub image Sub2 received in the time t3-t4 of the time axis t and thereby perform a synchronization error correcting operation.

Also, referring to FIG. 1 and FIG. 7B, it is assumed that on a time axis t, main image data Main of image data is received and is being played by a first display device among the plurality of display devices 300_1, . . . , 300_N, and two sub image data Sub1 and Sub2 are received and thereby are being played respectively by a second display device and a third display device among the plurality of display devices 300_1, . . . , 300_N.

In this case, due to an occurrence of a synchronization error, a third track of the second sub image Sub2 that needs to be received by the third display device and thereby be synchronized and be played with a third track of the main image data Main in a time t4-t5 of the time axis t may be received in a time t3-t4 of the time axis t.

To correct the above synchronization error, the synchronization control unit 240 may output a control signal CNT for performing a delay operation to suspend the third track of the second sub image Sub2 received in the time t3-t4 of the time axis t during a predetermined period of time, and playing gain the third track in the time t4-t5 of the time axis t, and thereby perform a synchronization error correcting operation.

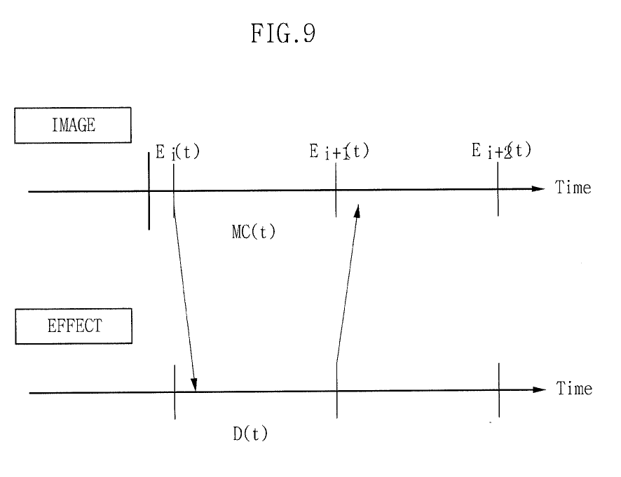

FIG. 8A, 8B and FIG. 9 are diagrams illustrating a synchronization error correcting operation of the synchronization control unit. In the present embodiment, a synchronization control operation of the synchronization control unit 240 occurring between image data and effect data will be described.

Referring to FIG. 1, 8A and FIG. 8B, in the case of real-sense effect data RD separated by the media parser 210 and thereby input into the device controller 230, a plurality of effects may exist in a time axis t as shown in (A).

In this case, the plurality of effects may include a light effect, a wind effect, a scent effect, and a heat effect.

The synchronization control unit 240 may generate a control signal CNT by analyzing the real-sense effect data RD. As shown in (B), the device controller 230 may define on/off with respect to each of the real-sense effect data RD based on the control signal CNT.

The defined real-sense effect data RD may be decoded by the effect data decoder 260, and be reproduced by the plurality of real-sense reproduction devices 400_1, . . . , 400_M.

Also, referring to FIG. 1 and FIG. 9, the device controller 230 may define a reproduction time of the real-sense effect data RD according to the control signal CNT transmitted from the synchronization control unit 240. In this case, the device controller 230 may consider a reproduction time where the real-sense effect data RD may be substantially reproduced.

For example, the device controller 230 may control an operation of the real-sense reproduction devices 400_1, . . . , 400_M based on a reproduction time E(t) of the image data, based on the following equation.

D(t)=MC(t)−δ(t)−N(t) [Equation]

In this case, D(t) denotes an operation time of the real-sense reproduction devices, MC(t) denotes total amounts of time of the image data played by the plurality of display devices, δ(t) denotes an activation time of the real-sense effect reproduction devices, and N(t) denotes a transmission time when the real-sense effect data is transmitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A method for a real-sense broadcasting service of a real-sense broadcasting system using a real-sense broadcasting content production apparatus, comprising:
generating media data by encoding at least one media source;
generating real-sense effect data by encoding at least one metadata, and generating a media file by inserting the real-sense effect data into the media data; and
converting the media file to a broadcasting signal and thereby outputting.

2. The method of claim 1, wherein the generating of the media file comprises:
selecting the at least one metadata corresponding to the media data from a plurality of metadata programmed using an extensible markup language (XML) format;
generating the real-sense effect data by encoding the selected at least one metadata; and
mixing the media data and the real-sense effect data.

3. The method of claim 1, wherein the converting of the media file to the broadcasting signal and thereby outputting comprises:
encoding each of a scene description and an object descriptor of the media file;
encoding each of a video source and an audio source of the media file;
encoding the real-sense effect data of the media file; and
synthesizing the encoded scene description and object descriptor, the encoded video source and audio source, and the encoded real-sense effect data.

4. The method of claim 3, wherein the converting of the media file to the broadcasting signal and thereby outputting encodes each of the scene description and object descriptor, the video source and audio source, and the real-sense effect data using a motion picture experts group 2 transport stream (MPEG2TS) format.

5. The method of claim 1, wherein each of the at least one media source and the at least one metadata is encoded using an MPEG-4 format.

6. A real-sense broadcasting content production apparatus of a real-sense broadcasting system using device cooperation, the real-sense broadcasting content production apparatus comprising:
a media file generator to generate media data by encoding at least one collected media source;
a metadata generator to generate real-sense effect data by encoding at least one metadata corresponding to the media data;
a mixing unit to output a media file by inserting the real-sense effect data into the media data; and
a signal converter to convert the media file to a broadcasting signal and thereby output.

7. The apparatus of claim 6, wherein the metadata generator selects the at least one metadata corresponding to the media data from a plurality of metadata programmed using an XML format, and thereby encodes the selected at least one metadata.

8. The apparatus of claim 6, wherein the signal converter comprises:
a first encoder to encode each of a scene description and an object descriptor of the media file;
a second encoder to encode each of a video source and an audio source of the media file;
a third encoder to encode the real-sense effect data of the media file; and
a synthesizer to synthesize an output of each of the first encoder, the second encoder, and the third encoder.

9. The apparatus of claim 8, wherein each of the first encoder, the second encoder, and the third encoder corresponds to an MPEG2TS encoder outputting data of an MPEG2TS format.

10. The apparatus of claim 6, wherein each of the media file generator and the metadata generator corresponds to an MP4 encoder outputting data of an MPEG-4 format.

11. A method for a real-sense broadcasting service of a real-sense broadcasting system using a real-sense broadcasting content play apparatus, comprising:
separating media data and real-sense effect data from a received broadcasting signal;
generating image data by decoding the media data, and playing the image data using at least one display device; and
generating effect data by decoding the real-sense effect data, and reproducing the effect data using at least one real-sense reproduction device by controlling the effect data to be synchronized with a play time of the image data.

12. The method of claim 11, wherein:
the image data comprises a video source and an audio source, and the playing of the image data comprises:
selecting, from a plurality of display devices, one display device to play the image data; and
outputting the image data to the selected display device and playing the image data by synchronizing a play time between the video source and the audio source of the image data.

13. The method of claim 11, wherein:
the image data comprise data for a main image and a plurality of sub images, and the playing of the image data comprises:
selecting, from a plurality of display devices, one display device to play the main image data and a remaining display device to play each of the sub image data;
outputting the main image data to the one display device, and outputting the sub image data to the remaining display device; and
synchronizing an operation time of the one display device and an operation time of the remaining display device so that a play time of the main image data is synchronized with a play time of the sub image data.

14. The method of claim 13, wherein the playing of the image data using the at least one display device further comprises:
correcting a synchronization error between the one display device and the remaining display device when the synchronization error occurs.

15. The method of claim 14, wherein the correcting of the synchronization error removes the sub image data where the synchronization error occurs.

16. The method of claim 14, wherein the correcting of the synchronization error delays the sub image data where the synchronization error occurs.

17. A real-sense broadcasting content play apparatus of a real-sense broadcasting system using device cooperation, the real-sense broadcasting content play apparatus comprising:
a media parser to separate media data and real-sense effect data from a received broadcasting signal;
a media controller to control a play time of the media data to be synchronized based on a synchronization control signal;
a device controller to control a reproduction time of the real-sense effect data to be synchronized with the media data based on the synchronization control signal; and
a synchronization control unit to generate and output a control signal for controlling a play synchronization of the media data or a reproduction synchronization of the real-sense effect data.

18. The apparatus of claim 17, wherein:
the image data comprises a video source and an audio source, and
the synchronization control unit outputs the control signal of synchronizing a play time between the video source and the audio source of the image data.

19. The apparatus of claim 17, wherein:
the image data comprises a single of main image data and a plurality of sub image data, and
the synchronization control unit outputs the control signal of synchronizing an operation time between display devices playing the main image data and the sub image data, respectively.
